(19) United States
(12) Patent Application Publication
(10) Pub. No.: US 2010/0188671 A1
(43) Pub. Date: Jul. 29, 2010

(54) Weighted Sheet Inspection

(75) Inventors: Andreas Ihme, Lengerich (DE); Alexander Klitza, Bocholt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: manroland AG, Offenbach (DE)

(21) Appl. No.: 12/296,065

(22) PCT Filed: Mar. 10, 2007
(86) PCT No.: PCT/EP07/02315

§ 371 Date: Mar. 29, 2010

(30) Foreign Application Priority Data
Apr. 3, 2006 (DE) 10 2006 015 828.8

(51) Int. Cl. G06K 9/00; G06F 15/00

(52) U.S. Cl. 358/1.9; 382/112

(57) ABSTRACT

An image processing system for use in a sheet-fed offset printing press inspects image data in a variable manner. and provides remediation in the event of a malfunction in order to reduce misprints, thus reducing waste and associated cost inefficiency.

### CROSS-REFERENCE TO RELATED APPLICATIONS

This patent application is a national phase of PCT/EP2007/002315, filed Mar. 10, 2007, which claims the benefit of German Patent Application No. DE 102006015828.8, filed Apr. 3, 2006, all of which are herein incorporated by reference in their entireties for all that they teach without exclusion of any part thereof.

### FIELD OF THE INVENTION

The present invention relates generally to an image processing system for a sheet-fed offset printing press including facilities for inspecting static and variable image data.

### BACKGROUND OF THE INVENTION

The invention relates to an image processing system for a printing press that is suitable for inspecting static and variable image data. The invention further relates to a printed product, as well as a method.

Printing technology malfunctions occurring during the printing process, such as the occurrence of slugs, can lead to a reduction of print quality and can lead to complaints from the end user under certain circumstances. In today's sheet-fed offset printing presses it is possible to perform sheet inspection, whereby errors occurring during the printing process can be recognized and displayed. It is additionally possible for sheets recognized as being faulty to be ejected or marked. The marking of faulty sheets with marking systems such as inkjet printing systems is particular advantageous if several copies are printed on one sheet and then only those copies that are faulty are marked. These marked copies can then be ejected in subsequent steps, so that it is not necessary to reject the entire sheet (and thus reject the good copies on the sheet).

Permanent monitoring of printed products is known today. For example, an imaging device in the form of a camera coupled with image processing facilities may be arranged in the last printing couple or at any other suitable point in a printing press. By means of such a recording device, it is possible to transmit a digital image of a printed image currently being printed to a memory. At that point, a comparison to an image of a good print copy can be made by means of image processing. Information regarding the quality and error level of a print is obtained from the comparison. This information can then be used to further process the printed products.

Such image processing systems are known from EP 1 190 855 A1 and EP 0 884 182 B1, among others. For example, the data obtained by the imaging device can be compared pixel-by-pixel to predetermined target values, whereupon either warnings are issued in case of aberrations, or corrective measures are taken in the printing process. With known image inspection systems, it is likewise possible to deposit the sheets into different stacks corresponding to the print quality. In that way, the spoiled product is separated and not supplied for further processing.

The reference DE 203 03 574 U1 describes a device for marking faulty copies on a printed sheet wherein these printed sheets are later separated into individual copies and the copies marked as faulty can then be rejected by suitable devices in further processing, among other places.

In connection with sheet inspection, one problem is that it is better if the user is able to assess the errors that are detected. Since the errors recorded by the sheet inspection system, particularly in the case of printed sheets containing several copies, can be situated in an area irrelevant to the product, i.e., the error can lie outside the printed zone or in an area not visible in the finished product (e.g., on the inside on a pasting tab), the user must be able to decide for each error whether and in what way it is relevant to the printed product. In addition to the position-related relevance of the error, the type of error also plays a role in the assessment of the ascertained error. Therefore it is possible that the error may be situated at a position on the sheet that is critical for the printed product, but is not sufficiently serious in its qualitative effect that the product must be considered a misprint. Furthermore, there is the additional problem in bank note printing that, with a continuous numbering of the bank notes (e.g., by stamping or in the engraving), the sheet inspection by the Eagle Eye always reports an error, because the changing numbering can of course not be stored as an image in the Eagle Eye. Here, too, there is the requirement of being able to assess some areas inside the copy differently from other areas, or even to mask them.

Based on the above-described requirements, a system is needed whereby the user is able to undertake individual, position-related or quality-related assessments of the recorded errors in order to be able to make a decision on the sorting of the individual copies into separate quality classes, or sorting of the copies considered defective copies out of the process, during or even after the actual printing process.

### OBJECTS AND SUMMARY OF THE INVENTION

The problem of the invention is to enable error detection in printed sheets according to selectable criteria. The problem is solved by an image inspection system for a printing press, in particular a sheet-fed offset press, in which the printing sheet is detected and the image signals that are obtained are processed in downstream image processing, wherein a printing sheet to be inspected by the image inspection system consists of several partial images, wherein the data of the partial images is assessed with respect to its position and/or with respect to its image contents and can be stored in a first memory for analysis by means of an image processing algorithm, and in that the data of the partial images obtained by an image processing system can be stored in a second memory for analysis by means of the image processing algorithm.

In another embodiment of the invention, the problem is solved by a method for quality control by means of an image inspection system in a printing press, in particular, a sheet-fed offset press, in which an image of the printing sheet is acquired and the image signals obtained are processed in downstream image processing, and wherein a printing sheet to be inspected by the image inspection system consists of several partial images, characterized in that the data of the partial images is assessed according to their position and/or with respect to their image contents, is provided with a priority level, and can be stored in a first memory for analysis by means of an image processing algorithm, and in that the data of the partial images obtained by an image processing system can be stored in a second memory for analysis by means of the image processing algorithm.

Other objects and advantages of the invention will become apparent upon reading the following detailed description and upon reference to the drawings, in which:

### BRIEF DESCRIPTION OF THE DRAWING

FIG. 1 is a schematic drawing showing processing of a sheet fed product according to embodiments of the invention. While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

In the image-processing system or in another system, for example, a computer system in the preprint stage, zones on the print image containing different data with respect to their relevance for the overall image are defined according to relevance. The relevance criteria are transferred to the image-processing system that processes the data recorded by the image inspection system. The zones containing data of differing relevance are processed by the image-processing system according to different criteria in the comparison to the respective reference values.

The methods specified in the invention are applicable, for example, for print images whose static content is printed, at least in part, in the offset printing method, and the variable content is printed during the print run with a known method such as laser printing, inkjet printing or a numbering unit.

In order to realize this, the printing sheet or each copy thereon should be subdivided by the user into differently prioritized areas (see Figure A in this regard). Depending on the weighting, the individual copy is furnished with a marking or a code that makes it possible to classify the respective copy as a function of the error and subsequently to be able to unambiguously identify it by means of a barcode scanner, for example, and then to reject it.

The error prioritization is done on two different assessment levels:

a) spatially-related and

b) quality-related.

In a spatially-related assessment, each individual copy is classified into areas with differing weighting, the error then being weighted as a function of its position in the respective area, e.g., with 100%, 80%, 60% or 40%. Each individual copy is marked corresponding to the established classification or assessment, wherein a weighting of 100% would classify the individual copy as a reject.

In the quality-related level, the prioritization is done according to the subjective impression of the user. Here, too, it should be possible to classify errors that occur according to quality losses of the final product and to be able to perform a ranking or prioritization. As in the spatially-related classification, the individual copy is marked according to the established priority degrees, even in the quality-related classification.

An identifying code or a marking is printed according to the classification of the recorded error on the various assessment levels, i.e., if a recorded error is ranked with a weight of the first priority degree on one of the two levels, then it is provided with a marking by, for example, an inkjet system, which identifies it as an unusable misprint.

Each of the assessment levels can contain an absolute weighting (e.g., 100%); nevertheless, the information of the code to be printed is always composed of the weights of these two assessment levels. The user can set his own classification of the marked copies (reject or process) before the respective rejection possibility or subsequently; e.g., if an error with a quality priority of 80% occurs in an area with a spatially-related assessment of 60%, then it is rejected since the point on the copy at which the error was identified does not have the highest priority, but the quality losses due to the error are so high that the final product will not be accepted.

The rejection copies with errors can take place downstream at the selection point of a gluing machine or at any other selection point provided in the production process. The user thereby retains control of the final product. He can decide at any time which quality levels will be permitted at which positions. The documentation achieved in this way then provides a very meaningful quality control. The information on position and quality, encrypted in a barcode, for example, is then printed with an output unit at any desired point, such as on a pasting tab. This can be done by means of an inkjet unit or a laser printer. If no code or marking is printed, the output unit can also be a sheet deflector. The sheet deflector rejects the entire sheet, but only according to the previously very precisely defined characteristics of position and quality.

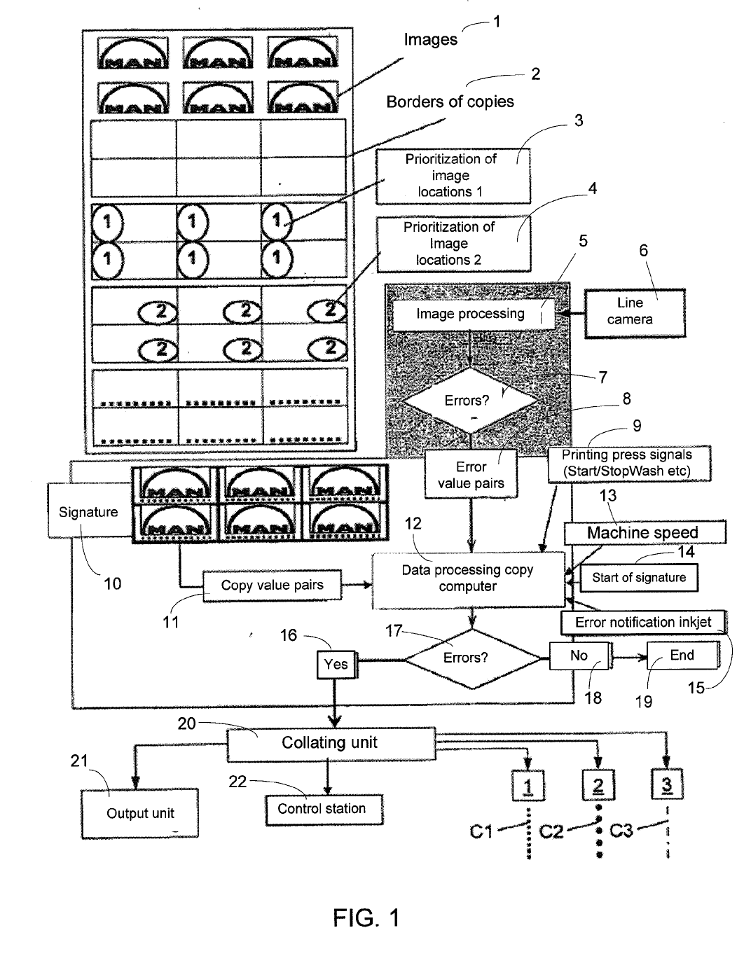

The invention will be briefly described with reference to the included drawing FIG. 1. A series of copies, each containing different image elements, are contained in a sketched-out printing sheet. As noted above, a different weighting of image contents can be provided position-dependently for each copy. Weightings for assessing the priorities (1) and (2) are assigned here for given areas. It can thus be seen that errors in the priority areas (1) are more serious than those in the priority areas (2).

The image contents can likewise be prioritized. These relate, for instance, to text elements that are of high importance for the partial images. Graphical elements, such as barcodes or the like, can also be of great significance for acquiring an overall impression. In this case, an image position-independent assessment, which can optionally be ranked higher, can take place. The position-related assessment, on the other hand, generally serves for excluding areas of the copy that have no external effect.

The corresponding data inside the print image is then transferred as copy value pairs in coordinates to a data processing system with a copy computer. Image processing, which analyzes an image detected with a line camera, is additionally associated with the data processing. The image processing detects errors that have occurred in the printing of the sheet and assigns these errors to error value pairs. The error value pairs are sent to data processing and thus to the copy computer. The data processing now assesses the possibilities for assessing and outputting printing errors, including press parameters such as press speed, marking of the signature start and availability of marking equipment (inkjet printers in this case) and the underlying errors and copy value pairs as described above.

If errors have occurred, a report may be issued, but in addition, a control output can also be derived in various manners by an output unit. For example, a faulty printing sheet can be directly rejected from the production process at a sorting device. These are preferably printing sheets that contain numerous errors of the highest priority level. On the other hand, each copy can also be provided with an imprint by means of several marking units 1, 2 or 3 if desired. Barcodes C1, C2 or C3 for this purpose, which can contain data on the nature and the weighting of the error, are shown. In this way, individual copies can be separated out by means of the marking in further processing. At the same time, it is now possible to monitor the production process by means of these otherwise detectable data, so that the amount and status of production can be continuously controllable.

The invention has various advantages, which will be summarized hereinafter. The decision to sort out copies recognized to be faulty can now be made after the actual printing process. This is done according to criteria of a predetermined position of the error on the individual copy and of a qualitative weighting with regard to its relevance to the content.

During the printing process, the recognized errors are assessed according to the criteria previously set by the operator and are unambiguously marked by a suitable marking system, such as an inkjet printer, with a barcode according to the error specification. The individual copies can be rejected or sorted on the basis of these unambiguous markings in further processing. This offers the possibility of avoiding spoilage and thus improving the quality assurance in sheet-fed offset printing.

With this expansion, the user obtains, in addition to the recognition of errors that occur during the printing process and the marking of faulty individual copies, the ability to weight the individual errors according to their effect on the end product.

### Weighted Sheet Inspection

The invention relates to an image processing system for a printing press according to the preamble of Claim 1 that is suitable for inspecting static and variable image data. The invention further relates to a printed product according to the preamble of Claim 9, as well as a method according to the preamble of Claim 10.

Printing technology malfunctions occurring during the printing process, such as slugs, lead to a reduction of print quality and can lead to complaints from the end user under certain circumstances. In today's sheet-fed offset printing presses there is a possibility for sheet inspection, whereby errors occurring during the printing process can be recognized and displayed. It is additionally possible for sheets recognized as being faulty to be ejected or marked. The marking of faulty sheets with marking systems such as inkjet printing systems is of particular advantage if several copies are printed on one sheet and then only those copies that are faulty are marked. These can then be ejected in subsequent steps, so that there is the advantage that it is not necessary to reject the entire sheet (and thus the good copies on it).

Permanent monitoring of printed products is state of the art today, in particular, if an imaging device in the form of a camera together with image processing is arranged in the last printing couple or at any other suitable point in a printing press. By means of such a recording device, it is possible to transmit a digital image of a printed image currently being printed to a memory. There a comparison to an image of a good print copy can be made by means of image processing. Information on the quality and freedom from flaws of a print is obtained from the comparison. The information can be linked to operations for further processing of the printed products.

Such image processing systems are known from EP 1 190 855 A1 and EP 0 884 182 B1, among others. For example, the data obtained by the imaging device is compared pixel-by-pixel to predetermined target values, whereupon either warnings are issued in case of aberrations, or corrective measures are taken in the printing process. With the known image inspection systems it is likewise possible to deposit the sheets into different stacks corresponding to the print quality. In that way, spoilage is separated and not supplied for further processing.

DE 203 03 574 U1 describes a device for marking faulty copies on a printed sheet wherein these printed sheets are later separated into individual copies and the copies marked as faulty can then be rejected by suitable devices in further processing, among other places.

In connection with the sheet inspection, the problem at hand is that there must be the possibility of being able to assess the errors that are detected.

Since the errors recorded by the sheet inspection system, particularly in the case of printed sheets containing several copies, can be situated in an area irrelevant to the product, i.e., the error can lie outside the printed zone or in an area not visible in the finished product (e.g., on the inside on a pasting tab), the user must be able to decide for each error whether and in what way it is relevant to the printed product. In addition to the position-related relevance of the error, the type of error also plays a role in the assessment of the ascertained error. Therefore it is possible that the error may be situated at a position on the sheet that is critical for the printed product, but is not sufficiently serious in its qualitative effect that the product must be considered a misprint. Furthermore, there is the additional problem in bank note printing that, with a continuous numbering of the bank notes (e.g., by stamping or in the engraving), the sheet inspection by the Eagle Eye always reports an error, because the changing numbering can of course not be stored as an image in the Eagle Eye. Here, too, there is the requirement of being able to assess some areas inside the copy differently from other areas, or even to mask them.

Based on the above-described requirements, it should be possible for the user to be able to undertake individual, position-related or quality-related assessments of the recorded errors in order thereby to be able to make a decision on the sorting of the individual copies into separate quality classes, or of sorting of the copies considered defective copies out of the process, during or even after the actual printing process.

The problem of the invention, in a system according to the preamble of Claim 1, is to enable error detection in printed sheets according to selectable criteria.

The problem is solved by the characteristics of a method according to Claim 10, by the characteristics of a printed product according to Claim 9, and by the characteristics of Claim 1 for a device.

In the image-processing system or in another system, for example, a computer system in the preprint stage, zones on the print image containing different data with respect to their relevance for the overall image are defined according to relevance. The relevance criteria are transferred to the image-processing system that processes the data recorded by the image inspection system. The zones containing data of differing relevance are processed by the image-processing system according to different criteria in the comparison to the respective reference values.

The methods specified in the invention find application preferably for print images whose static content is printed, at least in part, in the offset printing method, and the variable content is printed during the print run with a known method such as laser printing, inkjet printing or a numbering unit.

In order to realize this, it should be possible for the printing sheet or each copy thereon to be subdivided by the user into differently prioritized areas (see Figure A in this regard). Depending on the weighting, the individual copy is furnished with a marking or a code that makes it possible to classify the respective copy as a function of the error and subsequently to be able to unambiguously identify it by means of a barcode scanner, for example, and then to reject it.

The error prioritization is done on two different assessment levels:

a) spatially-related and

b) quality-related.

In a spatially-related assessment, each individual copy is classified into areas with differing weighting, the error then being weighted as a function of its position in the respective area, e.g., with 100%, 80%, 60% or 40%. Each individual copy is marked corresponding to the established classification or assessment, wherein a weighting of 100% would classify the individual copy as a reject.

In the quality-related level, the prioritization is done according to the subjective impression of the user. Here, too, it should be possible to classify errors that occur according to quality losses of the final product and to be able to perform a ranking or prioritization. As in the spatially-related classification, the individual copy is marked according to the established priority degrees, even in the quality-related classification.

An identifying code or a marking is printed according to the classification of the recorded error on the various assessment levels, i.e., if a recorded error is ranked with a weight of the first priority degree on one of the two levels, then it is provided with a marking by, for example, an inkjet system, which identifies it as an unusable misprint.

Each of the assessment levels can contain an absolute weighting (e.g., 100%); nevertheless, the information of the code to be printed is always composed of the weights of these two assessment levels. The user can set his own classification of the marked copies (reject or process) before the respective rejection possibility or subsequently; e.g., if an error with a quality priority of 80% occurs in an area with a spatially-related assessment of 60%, then it is rejected since the point on the copy at which the error was identified does not have the highest priority, but the quality losses due to the error are so high that the final product will not be accepted.

The rejection copies with errors can take place downstream at the selection point of a gluing machine or at any other selection point provided in the production process. The user thereby retains control of the final product. He can decide at any time which quality levels will be permitted at which positions. The documentation achieved in this way then provides a very meaningful quality control. The information on position and quality, encrypted in a barcode, for example, is then printed with an output unit at any desired point, such as on a pasting tab. This can be done by means of an inkjet unit or a laser printer. If no code or marking is printed, the output unit can also be a sheet deflector. The sheet deflector rejects the entire sheet, but only according to the previously very precisely defined characteristics of position and quality.

The invention will be briefly described with reference to the single FIGURE.

A series of copies, each containing different image elements, are contained in a sketched-out printing sheet.

According to the specification, a different weighting of image contents can be provided position-dependently for each copy. Weightings for assessing the priorities (1) and (2) are assigned here for given areas. It is thus made identifiable that errors in the priority areas (1) are more serious than those in the priority areas (2).

The image contents can likewise be prioritized. These relate, for instance, to text elements that are of high importance for the partial images. Graphical elements, such as barcodes or the like, can also be of great significance for acquiring an overall impression. In this case, an image position-independent assessment, which can optionally be ranked higher, can take place. The position-related assessment, on the other hand, generally serves for excluding areas of the copy that have no external effect.

The corresponding data inside the print image is then transferred as copy value pairs in coordinates to a data processing system with a copy computer.

Image processing, which analyzes an image detected with a line camera, is additionally associated with the data processing. The image processing detects errors that have occurred in the printing of the sheet and assigns these to error value pairs. The error value pairs are sent to data processing and thus to the copy computer. The data processing now assesses the possibilities for assessing and outputting printing errors, including press parameters such as press speed, marking of the signature start and availability of marking equipment (inkjet printers in this case) and the underlying errors and copy value pairs. This has been extensively described above in principle.

If errors have occurred, it is not only possible to issue a report. Instead, a control can also be derived in various manners by an output unit.

For one thing, a faulty printing sheet can be directly rejected from the production process at a sorting device. These are preferably printing sheets that contain numerous errors of the highest priority level. On the other hand, each copy can also be provided with an imprint by means of several marking units 1, 2 or 3 if desired. Barcodes C1, C2 or C3 for this purpose, which can contain data on the nature and the weighting of the error, are shown. In this way, individual copies can be separated out by means of the marking in further processing. At the same time, a possibility for monitoring the production process is opened by means of these otherwise detectable data, so that the amount and status of production can be continuously controllable.

The invention has various advantages:

The decision to sort out copies recognized to be faulty can now be made after the actual printing process. It is done according to criteria of a predetermined position of the error on the individual copy and of a qualitative weighting with regard to its relevance to the content.

During the printing process, the recognized errors are assessed according to the criteria previously set by the operator and are unambiguously marked by a suitable marking system, such as an inkjet printer, with a barcode according to the error specification. The individual copies can be rejected or sorted on the basis of these unambiguous markings in further processing. This offers the possibility of avoiding spoilage and thus improving the quality assurance in sheet-fed offset printing.

With this expansion, the user obtains, in addition to the recognition of errors that occur during the printing process and the marking of faulty individual copies, the possibility of weighting the individual errors according to their effect on the end product.

### Claims

1. Image inspection system for a printing press, in particular a sheet-fed offset press, in which the printing sheet is detected and the image signals that are obtained are processed in downstream image processing, wherein a printing sheet to be inspected by the image inspection system consists of several partial images, characterized in that the data of the partial images is assessed with respect to its position and/or with respect to its image contents and can be stored in a first memory for analysis by means of an image processing algorithm, and in that the data of the partial images obtained by an image processing system can be stored in a second memory for analysis by means of the image processing algorithm.

2. Image inspection system according to Claim 1, characterized in that after a comparison of the data from the first and second memories, printing sheets that have errors in partial image areas and/or image contents characterized by the first memory are rejected from the printing process via a sorting unit during passage through the printing press under control from the image inspection system.

3. Image inspection system according to Claim 1, characterized in that after a comparison of the data from the first and second memories, printing sheets that have errors in partial image areas and/or image contents characterized by the first memory are rejected from the printing process via a sorting unit under control from the image inspection system during the print cycle through the printing press.

4. Image inspection system according to Claims 1-3, characterized in that after a comparison of the data from the first and second memories, a marking device, such as an inkjet printer, under the control of the image inspection system, marks the copies or partial images that have errors in partial image areas and/or image contents characterized by the first memory as faulty during the print cycle through the printing press, and subsequently, they are sorted out in a suitable manner in an additional processing device.

5. Image processing system according to Claims 1-4, characterized in that the image processing system is installed in a sheet-fed offset press.

6. Method for quality control by means of an image inspection system in a printing press, in particular, a sheet-fed offset press, in which an image of the printing sheet is acquired and the image signals obtained are processed in downstream image processing, and wherein a printing sheet to be inspected by the image inspection system consists of several partial images, characterized in that the data of the partial images is assessed according to their position and/or with respect to their image contents, is provided with a priority level, and can be stored in a first memory for analysis by means of an image processing algorithm, and in that the data of the partial images obtained by an image processing system can be stored in a second memory for analysis by means of the image processing algorithm.

7. Method according to Claim 6, characterized in that

copies on the printing sheet having errors in areas or image contents designated as high-priority are marked by a marking device such as an inkjet printer during the print cycle through the printing press and are later sorted out in a suitable manner in a further processing machine.

8. Method according to Claim 6 or 7, characterized in that

an assessment of copies on the printing sheet is done in such a manner that errors in areas and/or image contents designated as low-priority are increased in value by errors in areas and/or image contents designated as high-priority.

9. Method according to Claims 6-8, characterized in that

an assessment of copies on the printing sheet is done in such a manner that errors in areas and/or image contents designated as low-priority are collected together with errors in areas and/or image contents designated as high-priority into an overall error value.

10. Method according to Claims 6-9, characterized in that

copies are provided with a marking corresponding to the overall error rate ascertained by the image inspection system.

11. Method according to Claim 10, characterized in that copies are rejected from further processing with a priority determined according to assessment levels corresponding to the printed marking for the overall error value.

### Weighted Sheet Inspection

The invention relates to an image processing system for a printing press according to the preamble of Claim 1 that is suitable for inspecting static and variable image data. The invention further relates to a printed product according to the preamble of Claim 9, as well as a method according to the preamble of Claim 10.

Printing technology malfunctions occurring during the printing process, such as slugs, lead to a reduction of print quality and can lead to complaints from the end user under certain circumstances. In today's sheet-fed offset printing presses there is a possibility for sheet inspection, whereby errors occurring during the printing process can be recognized and displayed. It is additionally possible for sheets recognized as being faulty to be ejected or marked. The marking of faulty sheets with marking systems such as inkjet printing systems is of particular advantage if several copies are printed on one sheet and then only those copies that are faulty are marked. These can then be ejected in subsequent steps, so that there is the advantage that it is not necessary to reject the entire sheet (and thus the good copies on it).

Permanent monitoring of printed products is state of the art today, in particular, if an imaging device in the form of a camera together with image processing is arranged in the last printing couple or at any other suitable point in a printing press. By means of such a recording device, it is possible to transmit a digital image of a printed image currently being printed to a memory. There a comparison to an image of a good print copy can be made by means of image processing. Information on the quality and freedom from flaws of a print is obtained from the comparison. The information can be linked to operations for further processing of the printed products.

Such image processing systems are known from EP 1 190 855 A1 and EP 0 884 182 B1, among others. For example, the data obtained by the imaging device is compared pixel-by-pixel to predetermined target values, whereupon either warnings are issued in case of aberrations, or corrective measures are taken in the printing process. With the known image inspection systems it is likewise possible to deposit the sheets into different stacks corresponding to the print quality. In that way, spoilage is separated and not supplied for further processing.

DE 203 03 574 U1 describes a device for marking faulty copies on a printed sheet wherein these printed sheets are later separated into individual copies and the copies marked as faulty can then be rejected by suitable devices in further processing, among other places.

In connection with the sheet inspection, the problem at hand is that there must be the possibility of being able to assess the errors that are detected.

Since the errors recorded by the sheet inspection system, particularly in the case of printed sheets containing several copies, can be situated in an area irrelevant to the product, i.e., the error can lie outside the printed zone or in an area not visible in the finished product (e.g., on the inside on a pasting tab), the user must be able to decide for each error whether and in what way it is relevant to the printed product. In addition to the position-related relevance of the error, the type of error also plays a role in the assessment of the ascertained error. Therefore it is possible that the error may be situated at a position on the sheet that is critical for the printed product, but is not sufficiently serious in its qualitative effect that the product must be considered a misprint. Furthermore, there is the additional problem in bank note printing that, with a continuous numbering of the bank notes (e.g., by stamping or in the engraving), the sheet inspection by the Eagle Eye always reports an error, because the changing numbering can of course not be stored as an image in the Eagle Eye. Here, too, there is the requirement of being able to assess some areas inside the copy differently from other areas, or even to mask them.

Based on the above-described requirements, it should be possible for the user to be able to undertake individual, position-related or quality-related assessments of the recorded errors in order thereby to be able to make a decision on the sorting of the individual copies into separate quality classes, or of sorting of the copies considered defective copies out of the process, during or even after the actual printing process.

The problem of the invention, in a system according to the preamble of Claim 1, is to enable error detection in printed sheets according to selectable criteria.

The problem is solved by the characteristics of a method according to Claim 10, by the characteristics of a printed product according to Claim 9, and by the characteristics of Claim 1 for a device.

In the image-processing system or in another system, for example, a computer system in the preprint stage, zones on the print image containing different data with respect to their relevance for the overall image are defined according to relevance. The relevance criteria are transferred to the image-processing system that processes the data recorded by the image inspection system. The zones containing data of differing relevance are processed by the image-processing system according to different criteria in the comparison to the respective reference values.

The methods specified in the invention find application preferably for print images whose static content is printed, at least in part, in the offset printing method, and the variable content is printed during the print run with a known method such as laser printing, inkjet printing or a numbering unit.

In order to realize this, it should be possible for the printing sheet or each copy thereon to be subdivided by the user into differently prioritized areas (see Figure A in this regard). Depending on the weighting, the individual copy is furnished with a marking or a code that makes it possible to classify the respective copy as a function of the error and subsequently to be able to unambiguously identify it by means of a barcode scanner, for example, and then to reject it.

The error prioritization is done on two different assessment levels:

a) spatially-related and

b) quality-related.

In a spatially-related assessment, each individual copy is classified into areas with differing weighting, the error then being weighted as a function of its position in the respective area, e.g., with 100%, 80%, 60% or 40%. Each individual copy is marked corresponding to the established classification or assessment, wherein a weighting of 100% would classify the individual copy as a reject.

In the quality-related level, the prioritization is done according to the subjective impression of the user. Here, too, it should be possible to classify errors that occur according to quality losses of the final product and to be able to perform a ranking or prioritization. As in the spatially-related classification, the individual copy is marked according to the established priority degrees, even in the quality-related classification.

An identifying code or a marking is printed according to the classification of the recorded error on the various assessment levels, i.e., if a recorded error is ranked with a weight of the first priority degree on one of the two levels, then it is provided with a marking by, for example, an inkjet system, which identifies it as an unusable misprint.

Each of the assessment levels can contain an absolute weighting (e.g., 100%); nevertheless, the information of the code to be printed is always composed of the weights of these two assessment levels. The user can set his own classification of the marked copies (reject or process) before the respective rejection possibility or subsequently; e.g., if an error with a quality priority of 80% occurs in an area with a spatially-related assessment of 60%, then it is rejected since the point on the copy at which the error was identified does not have the highest priority, but the quality losses due to the error are so high that the final product will not be accepted.

The rejection copies with errors can take place downstream at the selection point of a gluing machine or at any other selection point provided in the production process. The user thereby retains control of the final product. He can decide at any time which quality levels will be permitted at which positions. The documentation achieved in this way then provides a very meaningful quality control. The information on position and quality, encrypted in a barcode, for example, is then printed with an output unit at any desired point, such as on a pasting tab. This can be done by means of an inkjet unit or a laser printer. If no code or marking is printed, the output unit can also be a sheet deflector. The sheet deflector rejects the entire sheet, but only according to the previously very precisely defined characteristics of position and quality.

The invention will be briefly described with reference to the single FIGURE.

A series of copies, each containing different image elements, are contained in a sketched-out printing sheet.

According to the specification, a different weighting of image contents can be provided position-dependently for each copy. Weightings for assessing the priorities (1) and (2) are assigned here for given areas. It is thus made identifiable that errors in the priority areas (1) are more serious than those in the priority areas (2).

The image contents can likewise be prioritized. These relate, for instance, to text elements that are of high importance for the partial images. Graphical elements, such as barcodes or the like, can also be of great significance for acquiring an overall impression. In this case, an image position-independent assessment, which can optionally be ranked higher, can take place. The position-related assessment, on the other hand, generally serves for excluding areas of the copy that have no external effect.

The corresponding data inside the print image is then transferred as copy value pairs in coordinates to a data processing system with a copy computer.

Image processing, which analyzes an image detected with a line camera, is additionally associated with the data processing. The image processing detects errors that have occurred in the printing of the sheet and assigns these to error value pairs. The error value pairs are sent to data processing and thus to the copy computer. The data processing now assesses the possibilities for assessing and outputting printing errors, including press parameters such as press speed, marking of the signature start and availability of marking equipment (inkjet printers in this case) and the underlying errors and copy value pairs. This has been extensively described above in principle.

If errors have occurred, it is not only possible to issue a report. Instead, a control can also be derived in various manners by an output unit.

For one thing, a faulty printing sheet can be directly rejected from the production process at a sorting device. These are preferably printing sheets that contain numerous errors of the highest priority level. On the other hand, each copy can also be provided with an imprint by means of several marking units 1, 2 or 3 if desired. Barcodes C1, C2 or C3 for this purpose, which can contain data on the nature and the weighting of the error, are shown. In this way, individual copies can be separated out by means of the marking in further processing. At the same time, a possibility for monitoring the production process is opened by means of these otherwise detectable data, so that the amount and status of production can be continuously controllable.

The invention has various advantages:

The decision to sort out copies recognized to be faulty can now be made after the actual printing process. It is done according to criteria of a predetermined position of the error on the individual copy and of a qualitative weighting with regard to its relevance to the content.

During the printing process, the recognized errors are assessed according to the criteria previously set by the operator and are unambiguously marked by a suitable marking system, such as an inkjet printer, with a barcode according to the error specification. The individual copies can be rejected or sorted on the basis of these unambiguous markings in further processing. This offers the possibility of avoiding spoilage and thus improving the quality assurance in sheet-fed offset printing.

With this expansion, the user obtains, in addition to the recognition of errors that occur during the printing process and the marking of faulty individual copies, the possibility of weighting the individual errors according to their effect on the end product.

1-11. (canceled)

12. An image inspection system for a sheet-fed offset printing press, comprising:
means for detecting a printing sheet to produce image signals;
downstream image processing means for processing the image signals, wherein a printing sheet to be inspected by the image inspection system consists of several partial images; and
means for assessing the data of the partial images with respect to position and/or with respect to image contents;
first memory means for storing the partial images for analysis by means of an image processing algorithm; and
second memory means for storing the data of the partial images obtained by the image processing for analysis by means of the image processing algorithm.

13. The image inspection system according to claim 12, wherein after a comparison of the data from the first and second memories, printing sheets that have errors in partial image areas and/or image contents characterized by the first memory are rejected from the printing process via a sorting unit during passage through the printing press under control from the image inspection system.

14. The image inspection system according to claim 12, wherein after a comparison of the data from the first and second memories, printing sheets that have errors in partial image areas and/or image contents characterized by the first memory are rejected from the printing process via a sorting unit under control from the image inspection system during the print cycle through the printing press.

15. The image inspection system according to claim 12, wherein after a comparison of the data from the first and second memories, a marking device under the control of the image inspection system, marks the copies or partial images that have errors in partial image areas and/or image contents characterized by the first memory as faulty during the print cycle through the printing press, and subsequently, they are sorted in an additional processing device.

16. The image inspection system according to claim 12, wherein the image processing system is installed in a sheet-fed offset press.

17. A method for quality control via an image inspection system in a sheet-fed offset printing press, wherein a printing sheet to be inspected by the image inspection system consists of several partial images, the method comprising:
acquiring an image of a printing sheet to produce image signals;
processing the image signals in a downstream image processing system;
assessing data associated with the partial images according to position and/or image content; and
providing the image data with a priority level, wherein the image data is stored in a first memory for analysis by means of an image processing algorithm, and image data associated with the partial images is stored in a second memory for analysis by means of the image processing algorithm.

18. The method according to claim 17, wherein copies on the printing sheet having errors in areas or image contents designated as high-priority are marked by a marking device during the print cycle through the printing press and are later sorted out in a further processing machine.

19. The method according to claim 17, wherein an assessment of copies on the printing sheet is done in such a manner that errors in areas and/or image contents designated as low-priority are increased in value by errors in areas and/or image contents designated as high-priority.

20. The method according to claim 17, wherein an assessment of copies on the printing sheet is done such that errors in areas and/or image contents designated as low-priority are collected together with errors in areas and/or image contents designated as high-priority into an overall error value.

21. The method according to claim 17, wherein copies are provided with a marking corresponding to the overall error rate ascertained by the image inspection system.

22. The method according to claim 21, wherein copies are rejected from further processing with a priority determined according to assessment levels corresponding to the printed marking for the overall error value.

23. A computer-readable medium having thereon computer-executable instruction for performing a method of quality control via an image inspection system in a sheet-fed offset printing press, wherein a printing sheet to be inspected by the image inspection system consists of several partial images, the computer-executable instructions comprising:
instructions for acquiring an image of a printing sheet to produce image signals;
instructions for processing the image signals in a downstream image processing system;
instructions for assessing data associated with the partial images according to position and/or image content; and
instructions for providing the image data with a priority level, wherein the image data is stored in a first memory for analysis by means of an image processing algorithm, and image data associated with the partial images is stored in a second memory for analysis by means of the image processing algorithm.

24. The computer-readable medium according to claim 23, wherein copies on the printing sheet having errors in areas or image contents designated as high-priority are marked by a marking device during the print cycle through the printing press and are later sorted out in a further processing machine.

25. The computer-readable medium according to claim 23, wherein an assessment of copies on the printing sheet is done in such a manner that errors in areas and/or image contents designated as low-priority are increased in value by errors in areas and/or image contents designated as high-priority.
